(19) United States
(12) Patent Application Publication
(10) Pub. No.: US 2011/0298394 A1
(43) Pub. Date: Dec. 8, 2011

(54) HIGH EFFICIENCY FLASHLIGHT BEZEL

(76) Inventor: Paul Bower, Lake Mills, IA (US)

(21) Appl. No.: 13/152,232

(22) Filed: Jun. 2, 2011

Related U.S. Application Data
(60) Provisional application No. 61/350,902, filed on Jun. 2, 2010.

(51) Int. Cl. H05B 37/02; F21L 4/02

(52) U.S. Cl. 315/297; 362/184; 315/294

(57) ABSTRACT

A high efficiency flashlight bezel has a heat sink that controls the heat generated by at least one LED light source. The bezel is elongated to accommodate the heat sink. A constant current driver is attached to the back of the heat sink and connects the LED to the electrical power source housed in the flashlight body. The constant current driver keeps the light output steady throughout the entire run time and provides auto dimming for low battery reserve power. The bezel is adapted to fit on a traditional flashlight body thereby upgrading a flashlight without discarding it. The light output is four times the light output than conventional flashlights. Additionally, bulb life is greatly enhanced. The bezel is adapted to fit on a traditional flashlight body thereby upgrading a flashlight without discarding it.

### CROSS REFERENCE TO RELATED APPLICATIONS

This application claims priority and herein incorporates by reference U.S. provisional patent application 61/350,902 filed Jun. 2, 2010.

### BACKGROUND OF THE INVENTION

Light is fundamental to human activity and for thousands of years, fire was the only useful source of light besides the sun. At first burning sticks provided portable illumination, but was easy to put out and clumsy to use. Torches were a great improvement over sticks but still created dangerous gases and soot along with the hazards associated with open fire.

It is difficult to overestimate the impact that the creation of light using electricity has had on civilization. It has led to productivity unheard of before in history. Of course along with the creation of light, developments in electrical storage also led to our modern technological lifestyle. Long lasting, safe and easy to replace or recharge batteries has enabled us to take our gadgets with us everywhere and of course the flashlight has improved greatly since its inception.

High quality flashlights are expensive and need routine changing of bulbs and batteries. Once obtained, a user would have to purchase a new flashlight to take advantage of any improvements to bulb technology which is expensive and wasteful. There is a need for a replacement flashlight bezel that is adapted to fit on traditional flashlights that greatly improves performance.

### SUMMARY OF THE INVENTION

A high efficiency flashlight bezel has a heat sink that controls the heat generated by at least one LED light source. The bezel is elongated to accommodate the heat sink. A constant current driver is attached to the back of the heat sink and connects the LED to the electrical power source housed in the flashlight body. The constant current driver keeps the light output steady throughout the entire run time and provides auto dimming for low battery reserve power. The bezel is adapted to fit on a traditional flashlight body thereby upgrading a flashlight without discarding it. The light output is four times the light output than conventional flashlights. Additionally, bulb life is greatly enhanced. The bezel is adapted to fit on a traditional flashlight body thereby upgrading a flashlight without discarding it.

Other features and advantages of the instant invention will become apparent from the following description of the invention which refers to the accompanying drawings.

### BRIEF DESCRIPTION OF THE DRAWINGS

FIG. 1 is a cutaway view of a high efficiency flashlight bezel attached to a flashlight according to an embodiment of the invention.

FIG. 2 is a detailed view of a portion of the high efficiency flashlight bezel shown in FIG. 1.

FIG. 3 is a front view of the high efficiency flashlight bezel shown in FIG. 1.

FIG. 4 is a front view of a high efficiency flashlight bezel with a plurality of LED lights.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

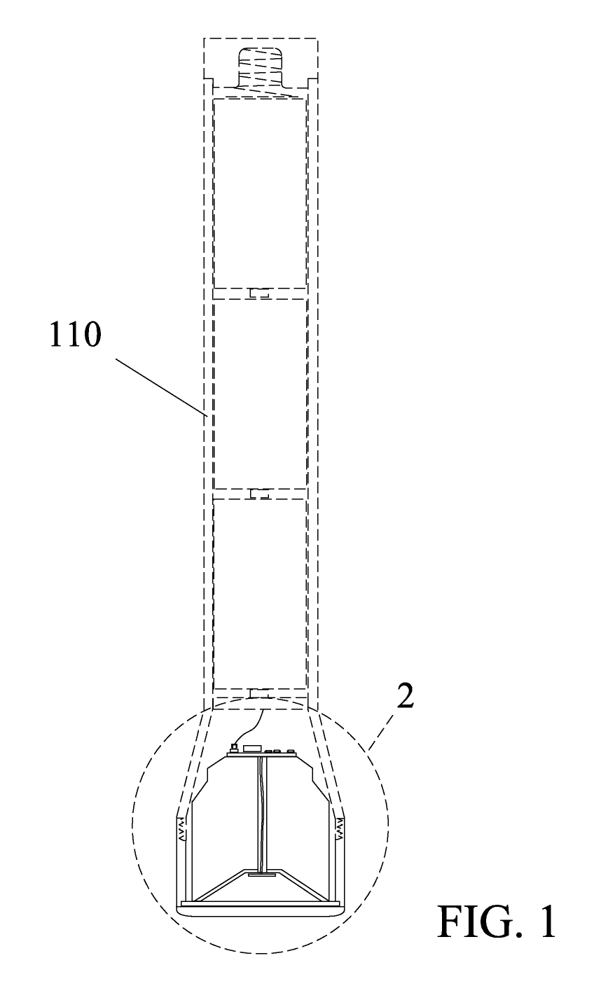

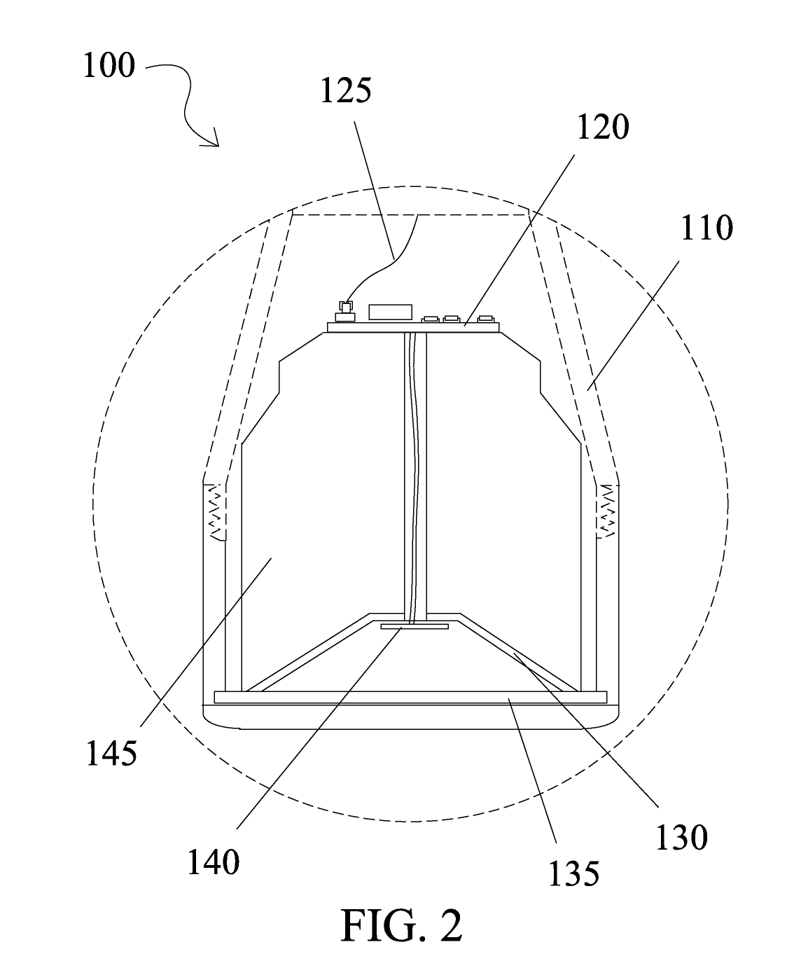

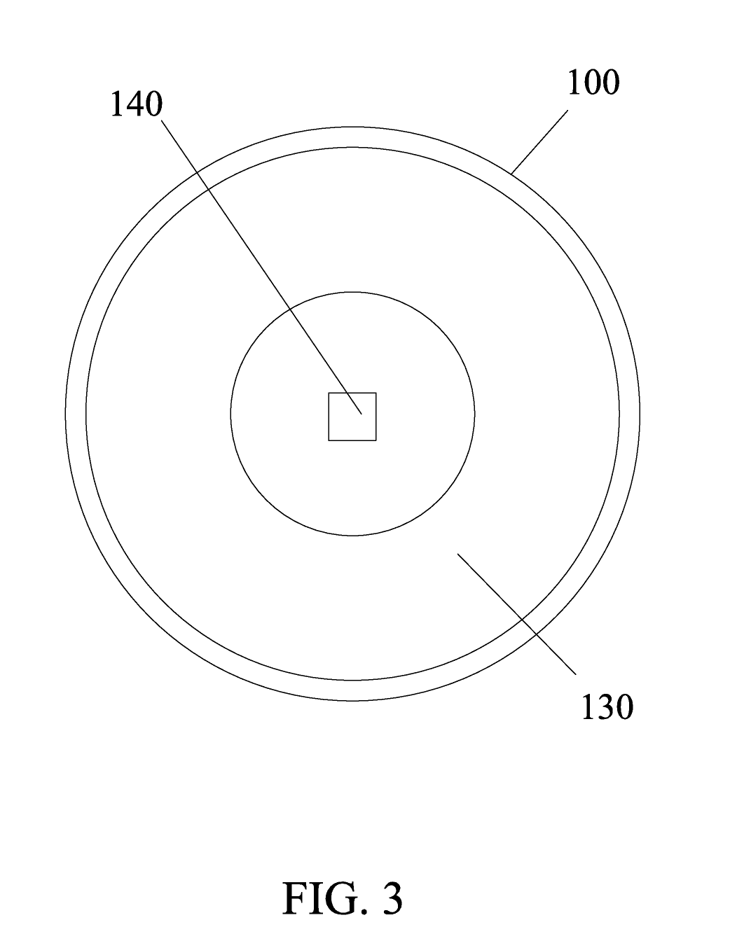

Referring to FIGS. 1 through 3, a high efficiency flashlight bezel 100 is shown attached to a flashlight body 110. Bezel 100 is adapted to screw on in place of the original bezel (not shown) that came with flashlight body 110. Of course not all flashlights have the same screw threads and different models may be offered to replace selected models.

Bezel 100 has a heat sink 145 that draws heat away from a LED light source 140 and a constant current driver 120. Constant current driver 120 drives LED 140 to operate at 100% light output almost until running out of electrical power rather than dimming during use as is common in traditional flashlights. Additionally, constant current driver 120 automatically dims LED 140 for low battery reserve power. A reflector 130 fits against a front portion of heat sink 145 to focus light back towards a selected direction as is known in the art. A lens 135 is provided to protect LED 140 and reflector 130. Of course other light sources may be used such as krypton, xenon, argon or halogen bulbs; HID (high intensity discharge) types. When a light source other than LED is used, the output will vary as the battery discharges.

Lens 135 is a polycarbonate to provide ruggedness but of course other transparent materials could be used. Heat sink 145 is made from aluminum due to its excellent heat transfer properties but of course other materials may be used as long as heat is effectively transferred. LED light sources are less sensitive to shock, vibration and temperature extremes and their lifetime are not reduced by frequent on/off switching. Various finishes such as billet aluminum, anodized, brushed, etc. may be used to enhance the esthetic quality of the bezel.

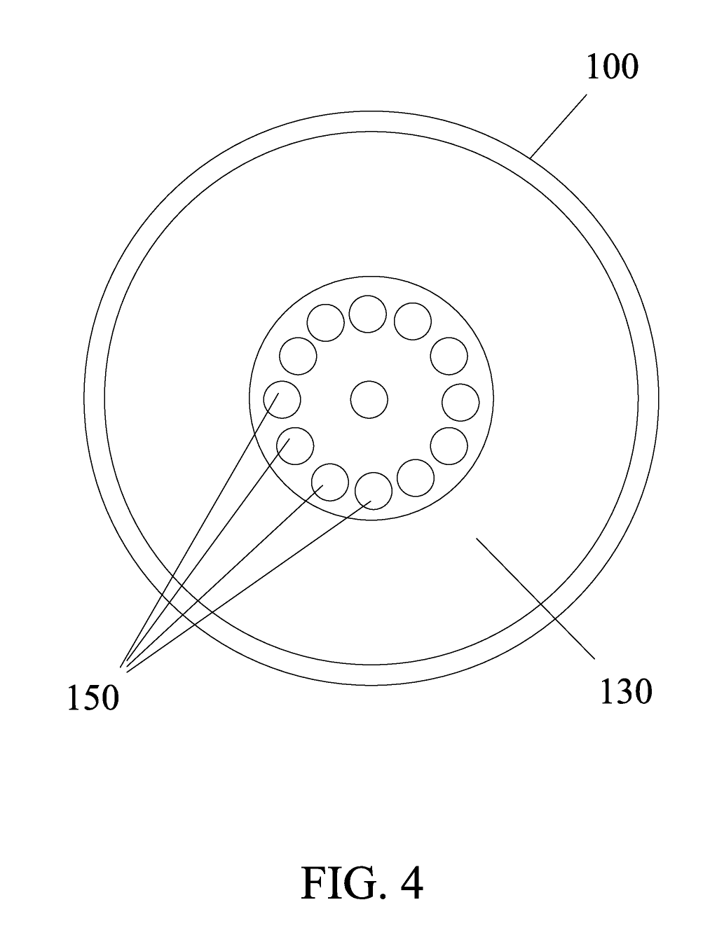

Referring now to FIG. 4, a high efficiency flashlight bezel 100 is shown having a plurality of LED 150 to increase light output. In this embodiment, a constant current driver (not shown) also controls multiple LED 150. Of course, the number of LED can vary from two to as many as can fit within a given space without departing from the disclosure and would be evident to a person skilled in the art.

Performance of high efficiency flashlight bezel is improved in a number of ways including increased brightness. The brightness of the single LED is four times as bright as a conventional bulb. The brightness of the LED is around 800 lumens. Additionally, the constant current driver also provides control functions such as auto dimming, power levels or flashing control, reverse polarity protection, etc. to further enhance the functionality therein.

To upgrade a flashlight, a user obtains a kit containing high efficiency flashlight bezel 100 as discussed above. The user detaches the power supply wiring 125 from the stock bezel and discards the stock bezel. The user attaches power supply wiring 125 to constant current driver 120. The user then attaches high efficiency flashlight bezel 100 to flashlight body 110. The flashlight is now upgraded.

Although the instant invention has been described in relation to particular embodiments thereof, many other variations and modifications and other uses will become apparent to those skilled in the art.

What is claimed is:

1. A high efficiency flashlight bezel comprises:
a bezel body portion;
a heat sink;
said heat sink adapted to fit within said body portion;
said body portion adapted to securely fit on a flashlight body;
at least one LED light source;
said LED light source is attached to a front side of said heat sink;
a control circuit;
said control circuit being in electrical communication with a power source and said at least one LED light source;
a reflector disposed around said at least one LED light source; and
A lens disposed within a front portion of said body wherein said at least one LED light source is protected.

2. The high efficiency flashlight bezel of claim 1 wherein said heat sink is made from aluminum.

3. The high efficiency flashlight bezel of claim 1 wherein said control circuit includes a dimming control function.

4. The high efficiency flashlight bezel of claim 3 wherein said dimming control function is automatically activated when a low power state is recognized.

5. A high efficiency flashlight bezel for use with an existing flashlight comprising:
a bezel body;
a heat sink;
said heat sink adapted to fit within said bezel body;
a bezel body attachment means for attaching said bezel body to a flashlight body;
at least one light source;
said at least one light source being in thermal contact with said heat sink;
a control means disposed within said bezel body for controlling said at least one light source;
said control means being adapted to interface with a power switch on said flashlight body;
a reflector disposed around said at least one LED light source; and
a lens disposed in a front portion of said bezel body wherein said at least one light source is protected.

6. The high efficiency flashlight bezel for use with an existing flashlight of claim 5 wherein said bezel body attachment means is a screw portion that is rotatably affixed to a matching screw portion of said flashlight body.

7. The high efficiency flashlight bezel for use with an existing flashlight of claim 5 wherein said control means is a control circuit.

8. The high efficiency flashlight bezel for use with an existing flashlight of claim 7 where said at least one light source is an LED light source.

9. The high efficiency flashlight bezel for use with an existing flashlight of claim 7 wherein said control circuit includes a low power control function wherein said LED light source is operated in a low power state.

10. A method of upgrading an existing flashlight with a high efficiency flashlight bezel comprising the steps of:
obtaining a kit containing a high efficiency flashlight bezel; said high efficiency flashlight bezel comprising:
a bezel body portion;
a heat sink;
said heat sink adapted to fit within said body portion;
said body portion adapted to securely fit on a flashlight body;
at least one LED light source;
said LED light source is attached to a front side of said heat sink;
a control circuit;
said control circuit being in electrical communication with a power source and said at least one LED light source;
a reflector disposed around said at least one LED light source; and
a lens disposed within a front portion of said body wherein said at least one LED light source is protected;
removing an existing bezel from said flashlight;
attaching said control circuit to existing power supply wiring; and
attaching said high efficiency flashlight bezel to said flashlight body.
